(19) United States
(12) Patent Application Publication
(10) Pub. No.: US 2016/0165227 A1
(43) Pub. Date: Jun. 9, 2016

(54) DETECTION OF AUDIO TO VIDEO SYNCHRONIZATION ERRORS

(71) Applicant: ARRIS Enterprises, Inc., Suwanee, GA (US)

(72) Inventors: Gautam Babbar, Philadelphia, PA (US); Daniel Hillegass, Warrington, PA (US); Olga Malysheva, Lansdale, PA (US); Gregory F. Maser, Schwenksville, PA (US); Pierre Brice, Edison, NJ (US); Janakiram Azhunjipakkam Panduragan, Bangalore (IN)

(21) Appl. No.: 14/801,034

(22) Filed: Jul. 16, 2015

Related U.S. Application Data
(60) Provisional application No. 62/087,460, filed on Dec. 4, 2014.

(51) Int. Cl. H04N 17/00; H04L 12/26; H04N 17/04

(52) U.S. Cl. CPC H04N 17/004; H04N 17/04; H04L 43/50

(57) ABSTRACT

A method of detecting the presence of unacceptable levels of audio to video synchronization errors in audio-video streams is provided. The method includes capturing, at a testing module, a test audio-video stream from a first source and a reference audio-video stream from a second source, extracting a test audio stream and a test video stream from the test audio-video stream, extracting a reference audio stream and a reference video stream from the reference audio-video stream, determining a highest correlation value between the test audio stream and the reference audio stream using cross-correlation, and determining that the test audio-video stream has an unacceptable level of AV-sync errors when the highest correlation value is above a preset correlation threshold.

### CLAIM OF PRIORITY

This Application claims priority under 35 U.S.C. §119(e) from earlier filed U.S. Provisional Application Ser. No. 62/087,460 filed Dec. 4, 2014, which is hereby incorporated by reference.

### TECHNICAL FIELD

The present disclosure relates to the field of video analysis, particularly determining whether audio and video streams are sufficiently synchronized.

### BACKGROUND

It can be distracting for a viewer of video content when audio associated with the video does not match up with images of actions occurring on the screen. This is noticed most frequently when people in a video are speaking, but the words they say do not appear to match up with their lip movements. For instance, the audio can be slightly delayed, such that syllables are heard after the lip movements that should produce those syllables are seen on screen. This type of temporal audio distortion can be referred to as a lip sync error. However, errors in audio to video synchronization can occur at any point in a video, even when people are not being shown on screen or are not speaking For instance, it can be distracting for viewers watching a baseball game when they see a bat hit a baseball but do not hear the corresponding crack of the bat until a second later.

In some instances, it can be acceptable if an audio stream is unsynchronized with a corresponding video stream by a few milliseconds, because that distortion is too small to be noticed by a viewer and the viewer can still perceive the audio and video as being sufficiently synchronized. For example, in many environments most viewers will not notice any synchronization errors if the audio leads the video, or lags behind the video, by less than 15 milliseconds. However, larger synchronization errors can become noticeable and distracting to viewers. As such, audio and video equipment manufacturers, as well as content producers and providers, generally desire to detect and minimize audio to video synchronization errors when audio and video streams are output to end-users.

Some existing methods have been introduced to attempt to detect audio to video synchronization errors. Some involve algorithms and/or neural networks that examine audio and video streams to check whether observed lip movements in the video stream match up with spoken words in the audio stream. However, these are specifically limited to lip sync errors and cannot be used to check for other types of audio to video synchronization errors when people are not shown speaking on screen.

Other audio to video synchronization error detection methods involve detecting parametric distortions based on known audio streams, or use custom video streams as test references. However, these methods cannot be used to check for synchronization errors with live video that has an audio stream that is not known ahead of time.

### SUMMARY

What is needed is a testing device and method that can examine live audio-video streams received from a test video device such as a set-top box and from a reference source, to compare the two audio-video streams to determine whether the test audio-video stream has unacceptable levels of AV-sync errors compared to the reference audio-video stream.

In one embodiment, the present disclosure provides for a method of detecting the presence of unacceptable levels of audio to video synchronization errors in audio-video streams, the method comprising capturing, at a testing module, a test audio-video stream from a first source and a reference audio-video stream from a second source, extracting a test audio stream and a test video stream from the test audio-video stream, extracting a reference audio stream and a reference video stream from the reference audio-video stream, determining a highest correlation value between the test audio stream and the reference audio stream using cross-correlation, and determining that the test audio-video stream has an unacceptable level of AV-sync errors when the highest correlation value is above a preset correlation threshold.

In another embodiment, the present disclosure provides for a testing module, the testing module comprising a first connection configured to receive a test audio-video stream from a first source, a second connection configured to receive a reference audio-video stream from a second source, and a processor configured to extract a test audio stream and a test video stream from the test audio-video stream, and a reference audio stream and a reference video stream from the reference audio-video stream, use cross-correlation to find a highest correlation value between the test audio stream and the reference audio stream, and determine that the test audio-video stream has an unacceptable level of AV-sync errors when the highest correlation value is above a preset correlation threshold.

In another embodiment, the present disclosure provides for a system comprising a test video device configured to receive an input audio-video stream from an external source, process the input audio-video stream, and output the input audio-video stream after processing as a test audio-video stream, a test module configured to receive the test audio-video stream from the test video device and a reference audio-video stream from a reference source, the test module having a processor configured to extract a test audio stream and a test video stream from the test audio-video stream, and a reference audio stream and a reference video stream from the reference audio-video stream, use cross-correlation to find a highest correlation value between the test audio stream and the reference audio stream, and determine that the test audio-video stream has an unacceptable level of AV-sync errors when the highest correlation value is above a preset correlation threshold.

### BRIEF DESCRIPTION OF THE DRAWINGS

Further details of the present invention are explained with the help of the attached drawings in which:

FIG. 1 depicts a testing module receiving a test audio-video stream from a test video device and a reference audio-video stream from a reference video device.

FIG. 2 depicts a flowchart for a process of comparing a test audio-video stream against a reference audio-video stream to determine whether the test audio-video stream has an unacceptable level of audio to video synchronization errors.

FIG. 3 depicts types of data used by a testing module when comparing a test audio-video stream and a reference audio-video stream according to the process of FIG. 2.

### DETAILED DESCRIPTION

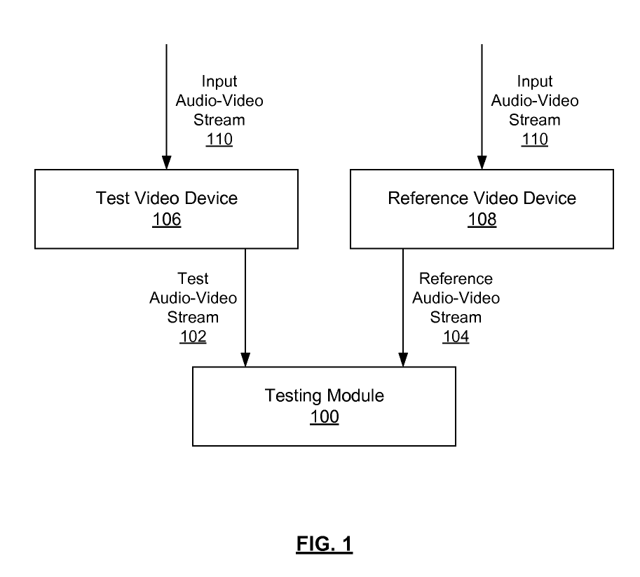

FIG. 1 depicts a testing module 100 receiving a test audio-video stream 102 and a reference audio-video stream 104. The testing module 100 can be a device configured to receive a test audio-video stream 102 from a first source and a reference audio-video stream 104 from a second source, and to compare the test audio-video stream 102 against the reference audio-video stream 104 to determine whether the test audio-video stream's audio component is sufficiently synchronized with test audio-video stream's video component.

In some embodiments the testing module 100 can be a personal computer with a video capture card configured to receive the test audio-video stream 102 and/or the reference audio-video stream 104, and/or an internet or other data network connection over which the test audio-video stream 102 and/or the reference audio-video stream 104 can be received. In other embodiments, the testing module 100 can be a handheld device, tablet computer, mobile device, signal processing device, or any other device configured to receive audio and video streams.

The test audio-video stream 102 can be an audio-video stream output to the testing module from a test video device 106. The test video device 106 can be configured to receive an input audio-video stream 110 from an external source such as a cable or satellite television provider, internet streaming video provider, over-the-air television signal provider, or any other source. The test video device 106 can be configured to process and/or decompress audio and video components of the input audio-video stream 110 and output an audio-video stream for display on another device such as a television or other monitor. By way of various non-limiting examples, the test video device 106 can be a set-top box, cable box, satellite box, digital video recorder, digital television adapter, digital video streaming device, game console, computer television tuner card, or any other type of device configured to receive, process, and output audiovisual streams. The test video device 106 can be connected to the testing module 100, such that the test video device's standard output derived from the input audio-video stream 110 that the test video device would normally transmit to televisions, speakers, and/or other display devices is transmitted to the testing module 100 as the test audio-video stream 102. In some embodiments the test video device 106 can output the test audio-video stream 102 to the test module 100 over a video connection, such as an HDMI, component video, S-video, or other video connection.

In some embodiments, the reference audio-video stream 104 can be an audio-video stream output to the testing module from a reference video device 108. The reference video device 108 can be configured to receive the same input audio-video stream 110 from the same source as the test video device 106. The reference video device 108 can be configured to process and/or decompress audio and video components of the input audio-video stream 110 and output an audio-video stream for display on another device such as a television or other monitor. By way of various non-limiting examples, the reference video device 108 can be a set-top box, cable box, satellite box, digital video recorder, digital television adapter, digital video streaming device, game console, computer television tuner card, or any other type of device configured to receive, process, and output audiovisual streams. The reference video device 108 can be connected to the testing module 100, such that the reference video device's standard output derived from the input audio-video stream 110 that the reference video device 108 would normally transmit to televisions, speakers, and/or other display devices is transmitted to the testing module 100 as the reference audio-video stream 104. In some embodiments the reference video device 108 can output the reference audio-video stream 104 to the test module 100 over a video connection, such as an HDMI, component video, S-video, or other video connection.

In other embodiments, the reference video device 108 can be absent, and the test module 100 can receive the reference audio-video stream 104 directly from a content provider without it being processed by an intermediate video device. By way of a non-limiting example, in some embodiments or situations the reference audio-video stream 104 can be the input audio-video stream 110 that is also received by the test video device 106. By way of another non-limiting example, in some embodiments or situations the reference audio-video stream 104 can be an audio-video stream transmitted directly to the testing module 100 over an internet or other network connection.

Audio-video streams can contain audio to video synchronization (AV-sync) errors, wherein the audio portion of the audio-video stream lags being ahead or leads its video portion. Such AV-sync errors can be noticeable and/or distracting to viewers when they exceed certain levels.

The test video device 106 can process the input audio-video stream 110 it receives in various ways prior to outputting it to other devices, such as decrypting an encrypted input audio-video stream 110 and/or decoding a compressed input audio-video stream 110. In some situations such processing by the test video device 106, or other software and/or hardware problems, can lead to AV-errors in the audio-video stream output by the test video device 106. The test module 100 can receive the test video device's output as the test audio-video stream 102, such that the test module 100 can compare the test audio-video stream 102 against the reference audio-video stream 104.

While the test audio-video stream 102 can have an unknown level of AV-sync errors, the reference audio-video stream 104 can be presumed to have an acceptable level of AV-sync errors by the testing module 100. By way of a non-limiting example, in embodiments in which the reference audio-video stream 104 is the output of a reference video device 108, the reference video device 108 can have been previously calibrated to output an audio-video stream with an acceptable level of AV-sync errors. By way of another non-limiting example, in embodiments in which the reference audio-video stream 104 is a stream received directly by the testing module 100, the reference audio-video stream 104 can be a stream from a provider known to transmit audio-video streams with an acceptable levels of AV-sync errors.

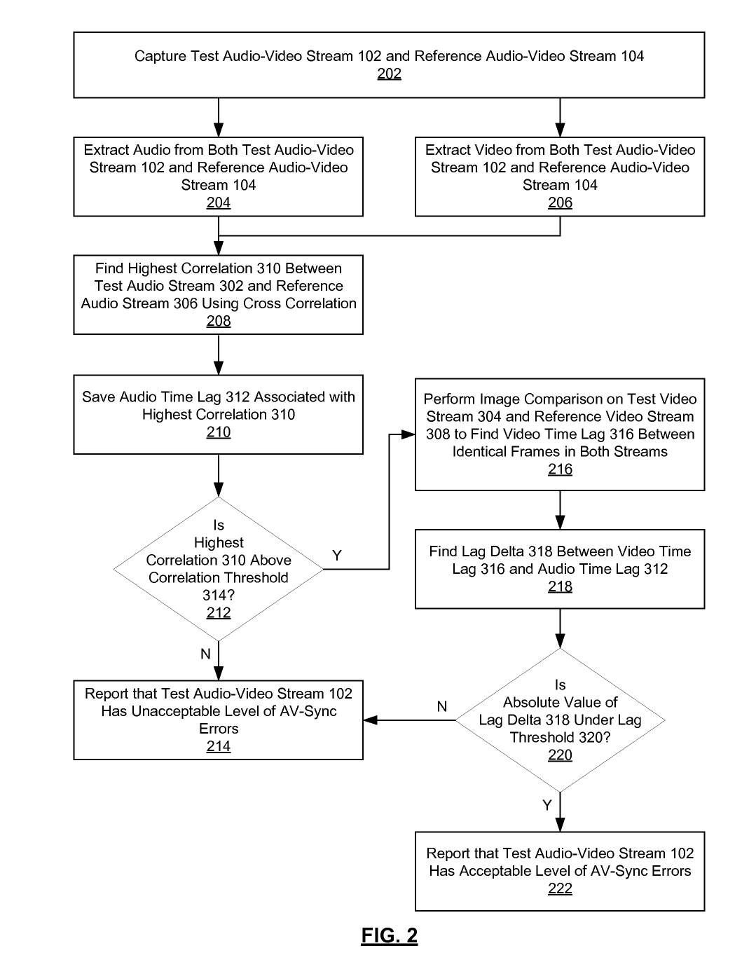

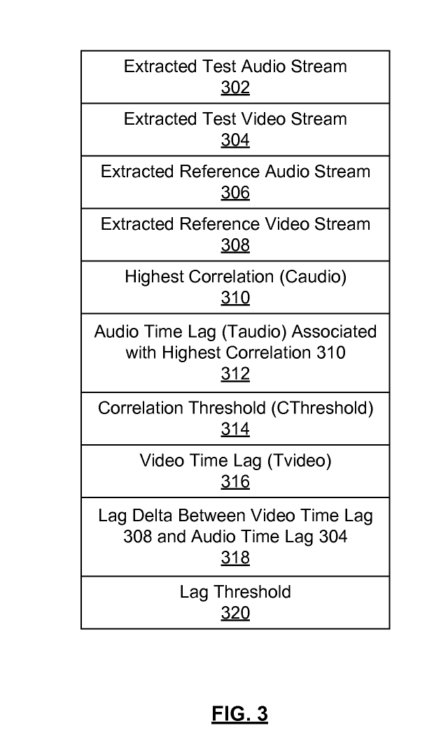

FIG. 2 depicts a flowchart for a method of comparing a test audio-video stream 102 against a reference audio-video stream 104 with a test module 100, to detect unacceptable levels of AV-sync errors in the test audio-video stream 102. The testing module 100 can use the data shown in FIG. 3 during the process of FIG. 2, including an extracted test audio stream 302, an extracted test video stream 304, an extracted reference audio stream 306, an extracted reference video stream 308, a highest correlation value 310, an audio time lag 312, a correlation threshold value 314, a video time lag 316, a lag delta 318, and a lag threshold 320.

At step 202, the testing module 100 can receive a test audio-video stream 102 and a reference audio-video stream 104. In some embodiments and/or situations the test audio-video stream 102 can be the output of a test video device 106 derived from an input audio-video stream 110 and the reference audio-video stream 104 can be the output of a reference video device 108 derived from the same input audio-video stream 110. By way of a non-limiting example, the test video device 106 and reference video device 108 can each receive the same input audio-video stream 110 from a provider, such as a live video stream or channel, individually process the input audio-video stream 110, and each output audio-video streams to the testing module 100. In other embodiments and/or situations the test audio-video stream 102 can be the output of a test video device 106 derived from an input audio-video stream 110, and the reference audio-video stream 104 can be a version of the same input audio-video stream 110 received directly by the testing module 100 from a streaming video provider over the internet or other data network, without processing by an intermediate reference video device 108. In still other embodiments and/or situations the test audio-video stream 102 can be the output of a test video device 106 derived from an input audio-video stream 110, and the reference audio-video stream 104 can be the same input audio-video stream 110 received directly by the testing module 100 without processing by an intermediate reference video device 108.

At steps 204 and 206, the testing module 100 can extract audio streams and video streams from both the test audio-video stream 102 and the reference audio-video stream 104. For example, the testing module 100 can extract a test audio stream 302 and a test video stream 304 from the test audio-video stream 102 by separating audio and video components from the test audio-video stream 102. Similarly, the testing module 100 can extract a reference audio stream 306 and a reference video stream 308 from the reference audio-video stream 104 by separating audio and video components from the reference audio-video stream 104.

At step 208, the testing module 100 can use cross-correlation to determine the highest correlation value 310 between the extracted test audio stream 302 and the extracted reference audio stream 306. By way of a non-limiting example, the testing module 100 can use a sliding dot product to find different correlation values between the test audio stream 302 and the reference audio stream 306 when the streams are offset by a plurality of different time lags. The highest of these different correlation values can be stored in memory in the testing module 100 as the highest correlation value 310. In some embodiments, the highest correlation value 310 can be referred to as “Caudio.”

At step 210, the testing module 100 can store in memory the time lag associated with the highest correlation value 310 as the audio time lag 312. In some embodiments, the audio time lag 312 can be referred to as “Taudio.”

At step 212, the testing module 100 can compare the highest correlation value 310 determined during step 208 against the correlation threshold 314. The correlation threshold 314 is a value that can be set depending on conditions such as the model or type of the test video device 106, the type or resolution of the audio-video streams being tested (such as standard resolution, high definition resolution, or ultra-high resolution), a platform resident on the test video device 106 (such as thinclient, KA, RDK, or any other platform), the type of connection between the test video device 106 and the testing module 100 (such as HDMI, component video, S-video, or any other connection), and/or any other factor. By way of a non-limiting example, in some embodiments or situations the correlation threshold 314 for a 720p stream output from a test video device 106 with a thinclient platform can be set at 0.75.

During step 212, if the highest correlation value 310 is found to be below the correlation threshold 314, the testing module 100 can determine that the test audio stream 302 and the reference audio stream 306 are not sufficiently correlated. The testing module 100 can accordingly report that the test audio-video stream 102 has an unacceptable level of AV-sync errors at step 214, because the test audio stream 302 and the reference audio stream 306 are not sufficiently correlated. However, if the highest correlation value 310 is above the correlation threshold 314, the testing module 100 can move to step 216 and/or step 218 to analyze corresponding video streams. In some embodiments the video processing of step 216 can occur after step 212 if the highest correlation value 310 of the audio streams was found to be above the correlation threshold 314. In alternate embodiments, the video processing of step 216 can occur in parallel with the audio processing of steps 208-210, and the testing module 100 can move directly to step 218 if the highest correlation value 310 was found to be above the correlation threshold 314.

At step 216, the testing module 100 can extract images from the extracted test video stream 304 and the extracted reference video stream 308. Extracted frames from one video stream can be compared with extracted frames from the other video stream to find identical frames from each stream. The time difference between the appearance of identical frames in each video stream can be stored in the testing module's memory as the video time lag 316. In some embodiments, the video time lag 316 can be calculated as the number of frames separating identical frames in each video stream, divided by the number of frames per second in the video streams. In some embodiments, the video time lag 316 can be referred to as “Tvideo.”

At step 218, the testing module 100 can determine the difference between the audio time lag 312 determined during step 210 and the video time lag 316 determined during step 216, and can store that difference in memory as the lag delta 318. By way of a non-limiting example, the audio time lag 312 can be subtracted from the video time lag 316 to find the lag delta 318.

At step 220, the absolute value of the lag delta 318 determined during step 218 can be compared against the lag threshold 320. As with the correlation threshold 314, the lag threshold 320 is a value that can be set depending on conditions such as the model or type of test video device 106, the type or resolution of the audio-video streams being tested (such as standard resolution, high definition resolution, or ultra-high resolution), a platform resident on the test video device 106 (such as thinclient, KA, RDK, or any other platform), the type of connection between the test video device 106 and the testing module 100 (such as HDMI, component video, S-video, or any other connection), and/or any other factor. By way of a non-limiting example, in some embodiments or situations the lag threshold 320 for a 720p stream output from a test video device 106 with a thinclient platform can be set at 0.5 seconds.

During step 220, if the lag delta 318 is found to be larger than the acceptable lag threshold 320, the testing module 100 can determine that the test audio-video stream 108 has a level of AV-sync errors that would likely be noticeable by a viewer of the test audio-video stream. The testing module 100 can accordingly report that the test audio-video stream 108 has an unacceptable level of AV-sync errors at step 214, because the audio components of the test audio-video stream 102 leads or lags behind the video components of the test audio-video stream 102 by a likely noticeable amount. However, if the lag delta 318 is lower than the acceptable lag threshold 320, the testing module 100 can accordingly report that the test audio-video stream 108 has an acceptable level of AV-sync errors at step 222.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A method of detecting the presence of unacceptable levels of audio to video synchronization errors in audio-video streams, comprising:
capturing, at a testing module, a test audio-video stream from a first source and a reference audio-video stream from a second source;
extracting, with said testing module, a test audio stream and a test video stream from said test audio-video stream;
extracting, with said testing module, a reference audio stream and a reference video stream from said reference audio-video stream;
determining, with said testing module, a highest correlation value between said test audio stream and said reference audio stream using cross-correlation; and
determining, with said testing module, that said test audio-video stream has an unacceptable level of AV-sync errors when said highest correlation value is above a preset correlation threshold.

2. The method of claim 1, further comprising:
comparing, with said testing module, one or more frames from said test video stream against one or more frames from said reference video stream and finding a video time lag between identical frames in said test video stream and said reference video stream;
finding, with said testing module, a lag delta between said video time lag and an audio time lag associated with said highest correlation value;
determining, with said testing module, that said test audio-video stream has an unacceptable level of AV-sync errors when the absolute value of said lag delta is higher than a preset lag threshold; and
determining, with said testing module, that said test audio-video stream has an acceptable level of AV-sync errors when the absolute value of said lag delta is lower than said preset lag threshold.

3. The method of claim 2, wherein said lag threshold is 0.5 seconds.

4. The method of claim 1, wherein said correlation threshold is 0.75.

5. The method of claim 1, wherein said first source is a first set-top box that receives and processes an input audio-video stream to generate said test audio-video stream and said second source is a second set-top box that receives and processes said input audio-video stream to generate said reference audio-video stream.

6. The method of claim 1, wherein said first source is a first set-top box that receives and processes an input audio-video stream to generate said test audio-video stream and said second source is a provider that transmits said reference audio-video stream to said testing module as a data stream over a data network.

7. The method of claim 1, wherein said testing module uses a sliding dot product to determine said highest correlation value.

8. A testing module, comprising
a first connection configured to receive a test audio-video stream from a first source;
a second connection configured to receive a reference audio-video stream from a second source; and
a processor configured to:
extract a test audio stream and a test video stream from said test audio-video stream, and a reference audio stream and a reference video stream from said reference audio-video stream;
use cross-correlation to find a highest correlation value between said test audio stream and said reference audio stream; and
determine that said test audio-video stream has an unacceptable level of AV-sync errors when said highest correlation value is above a preset correlation threshold.

9. The testing module of claim 8, wherein said processor is further configured to:
compare one or more frames from said test video stream against one or more frames from said reference video stream to find a video time lag between identical frames in said test video stream and said reference video stream;
find a lag delta between said video time lag and an audio time lag associated with said highest correlation value;
determine that said test audio-video stream has an unacceptable level of AV-sync errors when the absolute value of said lag delta is higher than a preset lag threshold; and
determine that said test audio-video stream has an acceptable level of AV-sync errors when the absolute value of said lag delta is lower than said preset lag threshold.

10. The testing module of claim 9, wherein said lag threshold is 0.5 seconds.

11. The testing module of claim 8, wherein said correlation threshold is 0.75.

12. The testing module of claim 8, wherein:
said test module receives said test audio-video stream over said first connection from a first set-top box that receives and processes an input audio-video stream to generate said test audio-video stream; and
said test module receives said reference audio-video stream over said second connection from a second set-top box that receives and processes said input audio-video stream to generate said reference audio-video stream.

13. The testing module of claim 8, wherein:
said test module receives said test audio-video stream over said first connection from a first set-top box that receives and processes an input audio-video stream to generate said test audio-video stream; and
said test module receives said reference audio-video stream over said second connection from a provider that transmits said reference audio-video stream to said testing module as a data stream over a data network.

14. The testing module of claim 8, wherein said processor uses a sliding dot product to determine said highest correlation value.

15. A system comprising:
a test video device configured to receive an input audio-video stream from an external source, process said input audio-video stream, and output said input audio-video stream after processing as a test audio-video stream;
a test module configured to receive said test audio-video stream from said test video device and a reference audio-video stream from a reference source, said test module having a processor configured to:
extract a test audio stream and a test video stream from said test audio-video stream, and a reference audio stream and a reference video stream from said reference audio-video stream;
use cross-correlation to find a highest correlation value between said test audio stream and said reference audio stream; and
determine that said test audio-video stream has an unacceptable level of AV-sync errors when said highest correlation value is above a preset correlation threshold.

16. The system of claim 15, wherein said processor is further configured to:
compare one or more frames from said test video stream against one or more frames from said reference video stream to find a video time lag between identical frames in said test video stream and said reference video stream;
find a lag delta between said video time lag and an audio time lag associated with said highest correlation value;
determine that said test audio-video stream has an unacceptable level of AV-sync errors when the absolute value of said lag delta is higher than a preset lag threshold; and
determine that said test audio-video stream has an acceptable level of AV-sync errors when the absolute value of said lag delta is lower than said preset lag threshold.

17. The system of claim 16, wherein said lag threshold is 0.5 seconds.

18. The system of claim 15, wherein said correlation threshold is 0.75.

19. The system of claim 15, wherein said reference source is a second video device configured to receive said input audio-video stream from said external source, process said input audio-video stream, and output said input audio-video stream after processing as said reference audio-video stream.

20. The system of claim 15, wherein said reference source is a provider that transmits said reference audio-video stream to said testing module as a data stream over a data network.
